(19) United States
(12) Patent Application Publication
(10) Pub. No.: US 2023/0196438 A1
(43) Pub. Date: Jun. 22, 2023

(54) SYSTEM FOR AWAKENING NON-SHOPPING CONSUMERS AND IMPLEMENTATION METHOD THEREOF

(71) Applicant: Awoo Intelligence, Inc., Taipei City (TW)

(72) Inventors: Szu Wu Lin, Taipei City (TW); Kuo Ming Lin, Taipei City (TW); Ting Rui Zhuo, Taipei City (TW)

(73) Assignee: Awoo Intelligence, Inc.

(21) Appl. No.: 17/752,618

(22) Filed: May 24, 2022

(30) Foreign Application Priority Data
Dec. 22, 2021 (TW) 110148300

(51) Int. Cl. G06Q 30/06; G06Q 30/02

(52) U.S. Cl. CPC G06Q 30/0631; G06Q 30/0605; G06Q 30/0255; G06Q 30/0269

(57) ABSTRACT

A system for awakening non-shopping consumers and an implementation method thereof employ artificial intelligence to grouping consumers, and then determine consumers who have not shopped for a long time, and provide products that meet consumers' needs by analyzing the results of the grouping, as the basis for consumers to shop. Moreover, the desire of consumers to buy goods can be promoted so as to awaken consumers who have not shopped for a long time.

### BACKGROUND OF INVENTION

### (1) Field of the Present Disclosure

The present disclosure relates to a system for awakening non-shopping consumers and an implementation method thereof, and more particularly a system that uses artificial intelligence to divide consumers into groups, and then uses the grouping results to awaken consumers who have not shopped for a long time and an implementation method thereof.

### (2) Brief Description of Related Art

The shopping journey of consumers is of great help to merchants in the marketing. Every step from selecting a product to purchasing a product contains potential business opportunities. For example, CN106485536A discloses a method and system for determining the next purchase time interval. By collecting customer consumption records, analyzing individual purchase behavior and crowd purchase behavior, and using the aforementioned two behaviors as variables, the individual purchase behavior time interval is determined. When the purchase activity of the customers is in the sleep state, the recommended time point and type of the most appropriate products are analyzed and recommended to the customer through the aforementioned customer consumption records.

However, when recommending appropriate products to consumers, CN106485536A only calculates individual and group variables in a single dimension based on consumers' purchase behaviors in a single location, such as time, location, and commodity, to infer the cycle of consumers in purchasing commodities at each location. Therefore, CN106485536A lacks multi-dimensional consideration and reference to the behavior of consumers, whether it is an individual or a group, and the attributes of the commodity when recommending the products required by consumers.

In addition, there are other relevant prior art as follows:

(1) CN107767217A “Shopping recommendation method, mobile terminal and storage medium”;

(2) CN110751515A “Decision-making method and device based on user consumption behavior”;

(3) JPA2019046189 “Extraction device, extraction method and extraction process”; and

(4) JPA2020047157 “Commodity Recommendation Device, Commodity Recommendation system and program”.

Accordingly, how to provide products that meet the needs of consumers based on multi-dimensional considerations, according to the behavior of consumers and the attributes of products, or increase the accuracy of placing and promoting products, so as to evoke consumers' desire to buy products, is a problem to be solved.

### SUMMARY OF INVENTION

It is a primary object of the present disclosure to provide a system for awakening non-shopping consumers and an implementation method thereof which are mainly based on the behavior of consumers and the attributes of products to provide products that meet the needs of consumers for increasing the accuracy of the products to be promoted, thereby arousing consumers' desire to buy products. In this way, the effect of waking up consumers who have not shopped for a long time is achieved.

According to the present disclosure, a data processing unit is based on a plurality of classification labels in a label database to classify and label path data generated by the user's operation of an information device and to store them in a path database. The path data are converted into vectorized data by an artificial intelligence module that has been trained for learning. Thereafter, the vectorized data are classified into grouped data. The path data are any data or a combination of a website trigger event, a website click event, a website operation behavior, a website stay time, and a derivative data under the aforementioned website operation behavior.

Furthermore, the data processing unit determines whether the user corresponding to the path data is a target to be awakened according to the path data with a plurality of the classification labels in the path database. Meanwhile, the artificial intelligence module matches the grouped data with at least one product data in the product database according to the target to be awakened, thereby creating a matching data. Finally, based on the matching data, the data processing unit extracts a relevant product data related to the matching data in the product database, and transmits it to the information device, so as to provide the user with more products that he may purchase. In addition, the matching data can be provided to the user for promoting more products. In this way, products that consumers are interested in can be accurately placed, so as to awaken consumers who have not shopped for a long time.

### BRIEF DESCRIPTION OF THE DRAWINGS

FIG. 1 is a block diagram of the system structure according to the present disclosure;

FIG. 2 is a flow chart of the method according to the present disclosure;

FIG. 3a is an implementation view I of the present disclosure;

FIG. 3b is an implementation view II of the present disclosure;

FIG. 4 is an implementation view III of the present disclosure;

FIG. 5 is a detailed flow chart of the method according to the present disclosure;

FIG. 6 is an implementation view IV of the present disclosure;

FIG. 7a is an implementation view V of the present disclosure; and

FIG. 7b is an implementation view VI of the present disclosure.

### DETAILED DESCRIPTION OF PREFERRED EMBODIMENTS

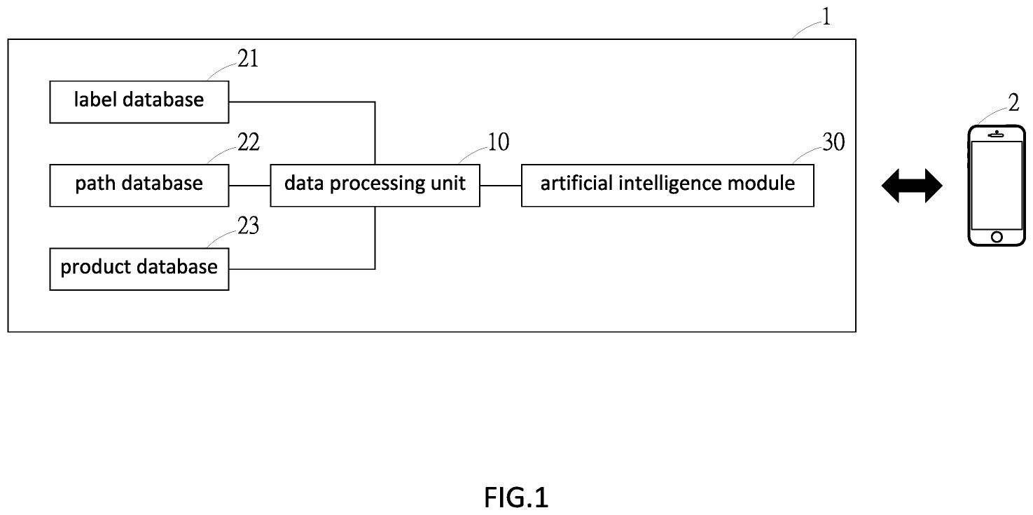

Referring to FIG. 1, the system 1 for awakening non-shopping consumers of the present disclosure is in informational connection with an information device 2, and mainly includes a data processing unit 10, which is respectively in informational connection with a label database 21, a path database 22, a product database 23 and an artificial intelligence module 30. In addition, the information device 2 can be one of a mobile phone, a tablet computer, a personal computer and the like.

The data processing unit 10 can be used to drive the above-mentioned modules and databases, to classify an input data label, such as path data and product data, generated when the user operates the information device 2, and has the functions of receiving and transmitting information signals, logical operations, temporary storage of operation results, and storage of execution command positions. The data processing unit 10 can be a central processing unit (CPU) or a microcontroller unit (MCU).

The label database 21, the path database 22, and the product database 23 can be used to store electronic data, which can be any one or a combination of a solid state disk or solid state drive (SSD), a hard disk drive, (HDD), a static random access memory (SRAM), a random access memory (DRAM), and a cloud drive.

The label database 21 mainly stores a plurality of classification labels for the data processing unit 10 to classify the input data labels. The path database 22 mainly stores a path vector learning data, a vector grouping learning data, a historical data, and a path data. Each of the above-mentioned data can be pre-input data from an external database. The historical data can be the data calculated and processed by the system itself. After the system has processed the data information, it can be classified as path vector learning data and vector grouping learning data. The path data can be input data generated when the user operates the information device 2. The input data can be any data or a combination of a website trigger event (such as a webpage hyperlink), a website click event (such as clicking on an advertisement), a website operation behavior (such as purchasing a product, searching for a product), a website stay time, and a derivative data (such as shopping cart data, or product data included in purchased goods) under the aforementioned website operation behavior. It is understood that the invention is not limited thereto. The aforementioned path data may respectively contain a plurality of classification labels. The product database 23 mainly stores a product data which can be any data or a combination of a product type, a product name, a product price, a product function. It is understood that the invention is not limited thereto. The above-mentioned product data can be input data generated when the user operates the information device 2, or product data pre-input from an external database. The aforementioned product data may respectively include a plurality of classification labels.

The artificial intelligence module 30 can be used for training and learning through the path vector learning data and the vector grouping learning data, converting the path data into a vectorized data, and then classifying a plurality of vectorized data into a grouped data. The artificial intelligence module 30 can be trained and learned through machine learning such as supervised learning, semi-supervised learning, reinforcement learning, unsupervised learning, self-supervised learning, or heuristic algorithms.

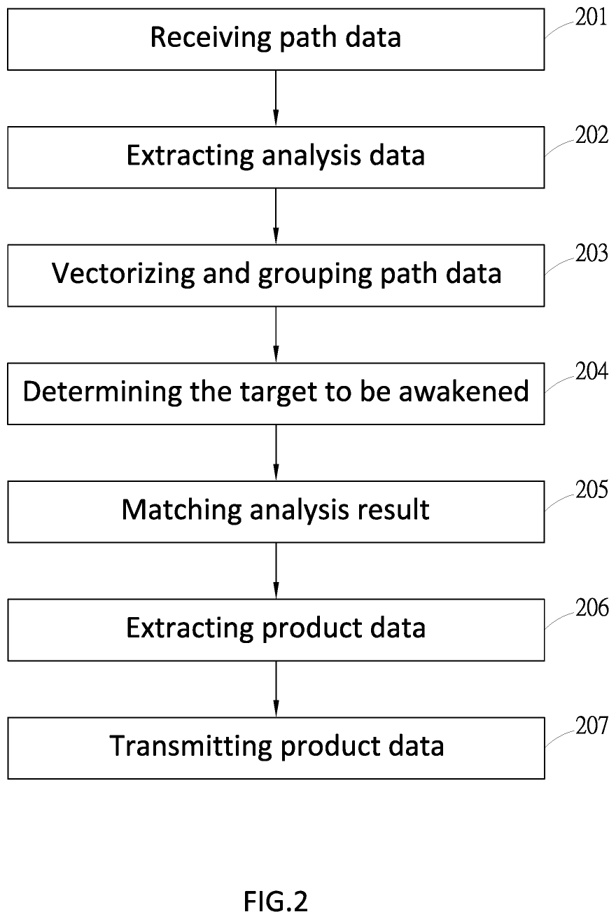

As shown in FIG. 2, the method for awakening non-shopping consumers includes the following steps:

Receiving path data 201: The system 1 for awakening non-shopping consumers receives a path data generated when the user operates the information device 2. A data processing unit 10 classifies the path data based on a plurality of classification labels in a label database 21. The path data with the plurality of classification labels is then transmitted to the path database 22 for storage. The path data can be any data or a combination of a website trigger event (such as a webpage hyperlink), a website click event (such as clicking on an advertisement), a website operation behavior (such as purchasing a product, searching for a product), a website stay time, and a derivative data under the aforementioned website operation behavior. It is understood that the invention is not limited thereto. The above-mentioned path data can also be data pre-input from an external database. The derivative data can be any data of a shopping cart, or a product data included in the purchased product, or a combination thereof.

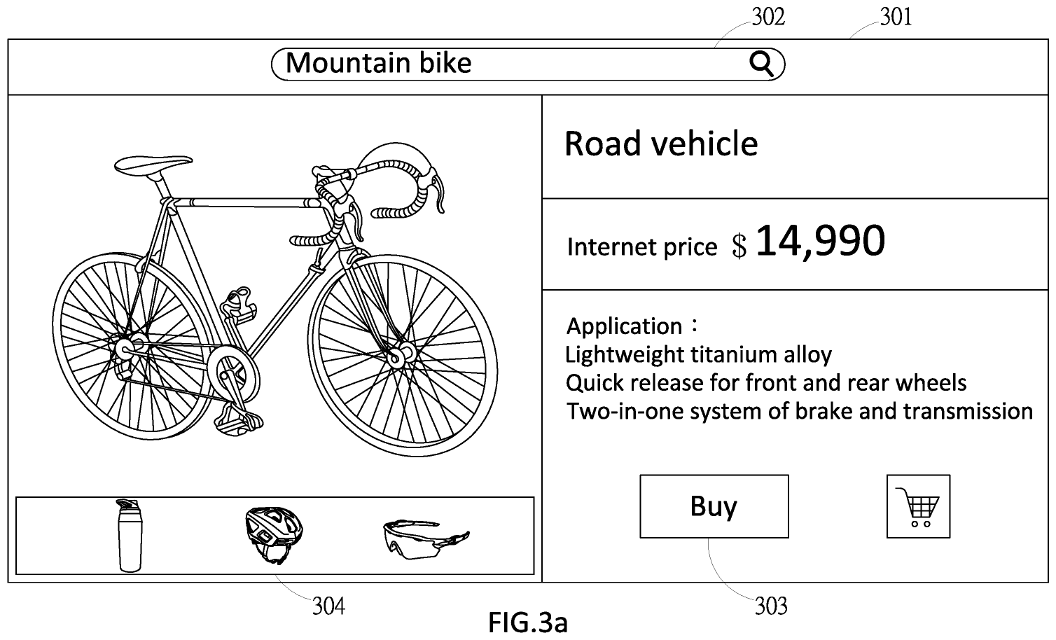

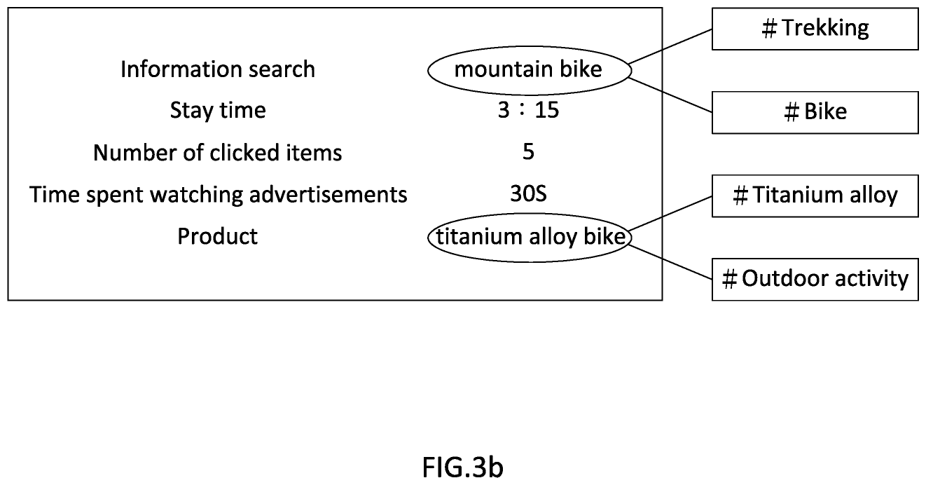

In one embodiment, referring to FIG. 3a and FIG. 3b, the user browses a website page 301 through the information device 2, inputs “mountain bike” in a search unit 302 in the website page 301, and selects to browse two kinds of products, clicks a purchase unit 303 to buy one of the titanium alloy road bikes, and triggers three advertisements of an advertisement unit 304. The website trigger event, the website click event, the website operation behavior, the website stay time, and the derivative data under the aforesaid website operation behavior generated when the user visits the website page 301 will be marked with a plurality of classification labels by the data processing unit 10. For example, the data processing unit 10 marks the user's search information “mountain bike” (path data) with a trekking label, a bike label, etc. Moreover, the purchased “titanium alloy bike” (derivative data) can be marked with a titanium alloy label, an outdoor sports label, etc. The path data with a plurality of classification labels is then transmitted to the path database 22 for storage. The above-mentioned examples are only examples. It is understood that the invention is not limited thereto.

Extracting analysis data 202: The data processing unit 10 extracts a plurality of path data in the path database 22 and at least one product data in the product database 23 for analysis by an artificial intelligence module 30. The path data and the product data each include a plurality of classification labels. The product data can be input data generated when the user operates the information device 2, or the product data is pre-entered from an external database. For example, if a merchant wants to sell a special bag for river tracing, the special bag (input data) will be affixed with an outdoor sports label and a waterproof material label. Alternatively, the system of the present invention is connected to an external database in which the products are pre-labeled with corresponding classification labels.

Vectorizing and grouping path data 203: The artificial intelligence module 30 performs vectorized analysis on the path data to generate a vectorized data. Thereafter, a plurality of vectorized data are defined as a grouped data with a plurality of classification labels.

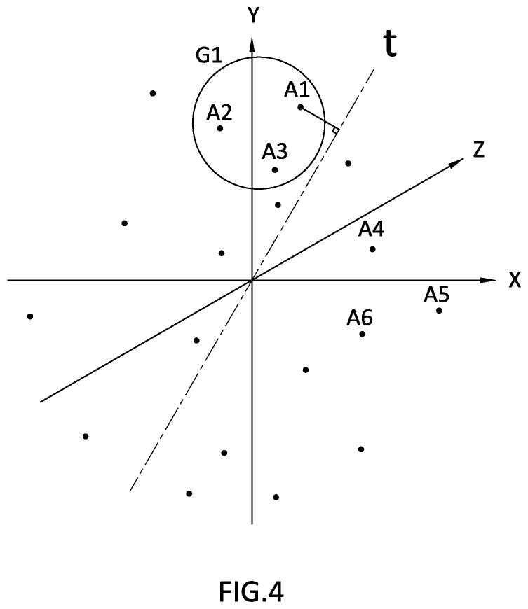

In one embodiment according to FIG. 4, the artificial intelligence module 30 stacks and converts a plurality of path data into a multi-dimensional vector matrix. If a user stays on the website for 3 minutes and 45 seconds, clicks on 3 products on the website, and watches 2 advertisements placed on the website for a total of 30 seconds, the artificial intelligence module 30 converts the path data of the user a into a vectorized data A1 [0.33, 2, 0.3] ([total stay time, number of clicked items, time spent watching advertisements]). The present invention employs the three-dimensional vector matrix. It is understood that the invention is not limited thereto. The vectorized data A1-A6 can be the vectorized data of different users, for example, the vectorized data A2 can be the vectorized data of a user b, and the vectorized data A3 can be the vectorized data of a user c, etc. A tangent line t can represent that the artificial intelligence module 30 divides the vectorized data A1 to A6 into two parts under a certain grouping training theme. The vectorized data A1˜A3 can be classified into a grouped data G1. Since the artificial intelligence module 30 is trained by different path vector learning data and vector grouping learning data, the slope and the direction of the tangent t are different, which makes the grouped data different. The above-mentioned are only examples. It is understood that the invention is not limited thereto

Determining the target to be awakened 204: The data processing unit 10 determines a target to be awakened based on a plurality of the classification labels of the path data, that is, the data processing unit 10 determines whether the user corresponding to the path data is a target to be awakened according to the path data with a plurality of the classification labels in the path database 22. A plurality of the classification labels are assigned to the target to be awakened.

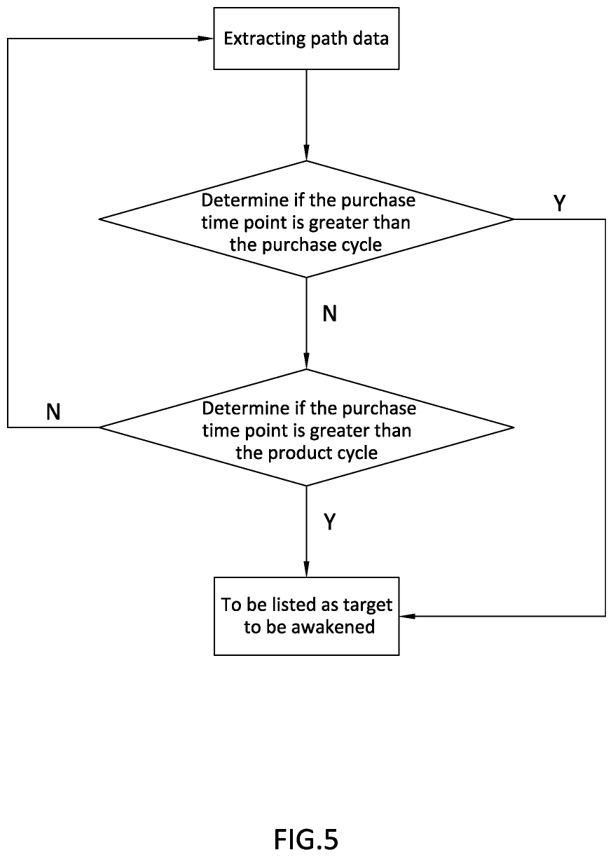

Referring to FIG. 5, the data processing unit 10 extracts a piece of path data in the path database 22, and determines whether the corresponding purchase time point of the user is greater than the purchase cycle. If so, the user is listed as the target to be awakened. If not, it is determined whether the purchase time point is greater than the product cycle of the previously purchased product. If so, the user is listed as the target to be awakened. If not, the data processing unit 10 extracts another piece of path data from the path database 22. The product cycle can be any one or a combination of the product life cycle of the product itself and the product life cycle of the related product itself. For example, if the user a buys stationery once a month and he has not purchased stationery for more than a month, then the user a is listed as a target to be awakened. Another example is that a user b buys a mobile phone once a year and buys another mobile phone less than one year. However, the product life cycle of the mobile phone itself does not exceed the purchase cycle. According to the relevance of the products, it is determined that the user b may need related products, such as bluetooth earphones, or needs to replace the charging cable of the mobile phone, then the user b is still listed as the target to be awakened.

Matching analysis result 205: The artificial intelligence module 30 matches the grouped data with the product data based on the target to be awakened to generate a matching data, that is, the artificial intelligence module 30 matches the classification label included in the grouped data with the classification label included in the product data according to the classification label of the target to be awakened.

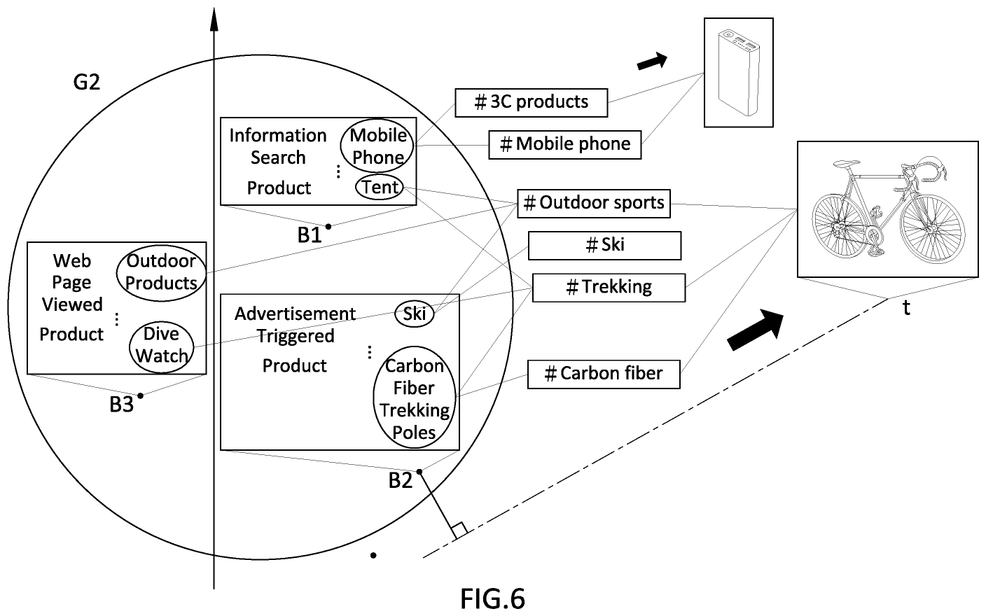

Referring to FIG. 6, the vectorized data B1 is the vectorized data of a user d, the vectorized data B2 is the vectorized data of a user e, and the vectorized data B3 is the vectorized data of a user f. The vectorized data B1˜B3 can be classified as a grouped data G2. The data processing unit 10 determines that the user e is the target to be awakened. The artificial intelligence module 30, according to the grouped data G2 where the user e is allocated, respectively matches the classification labels included in the vectorized data B1˜B3 contained in the grouped data G2 to the classification labels of the product data. For example, the user d has searched for mobile phones and purchased tents. Therefore, a 3C product label, a mobile phone label, a trekking label, an outdoor sports label, etc. are assigned to the user d. The user e has watched ski advertisements and purchased carbon fiber trekking pole. Therefore, a ski label, a carbon fiber label, an outdoor sports label, a trekking label, etc. are assigned to the user e. The user f has purchased a diving watch on an outdoor product website. Therefore, a diving label, a 3C product label, an outdoor sports label, etc. are assigned to the user f. When the data processing unit 10 determines that the user e is the target to be awakened, it is inferred according to the classification label of the user e that he may purchase a bicycle with an outdoor activity label and a carbon fiber label. At the same time, the artificial intelligence module 30, according to the grouped data G2 where the user e is allocated, matches the 3C product labels, mobile phone labels, trekking labels, outdoor sports labels, etc. included in the grouped data G2 to the classification labels of the product data. For example, the 3C product label and the mobile phone label are assigned to the mobile power supply. In this way, the artificial intelligence module 30 determines that the user e may need the mobile power supply, and then generates the matching data: the mobile power supply.

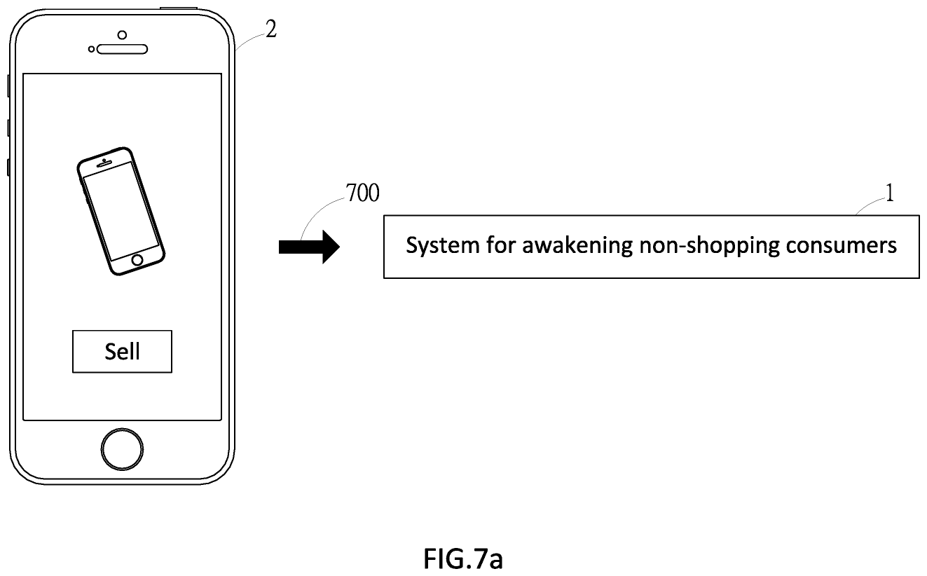

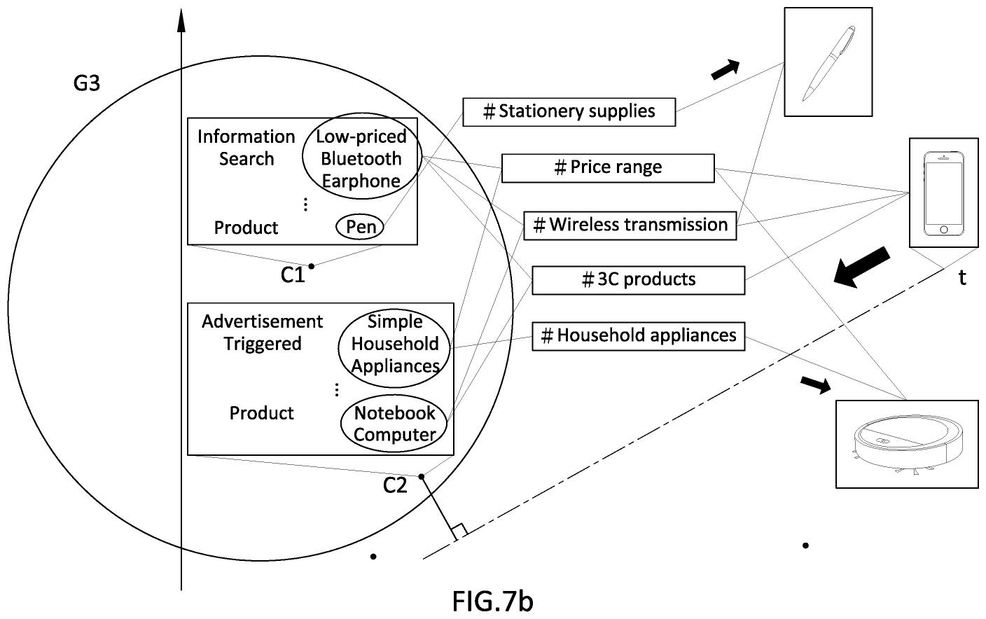

Referring to FIG. 7a and FIG. 7b, the system 1 for awakening non-shopping consumers of the present invention receives a sales promotion data 700 generated when the user operates the information device 2. The sales promotion data 700 can be product data, which can be any one of a product type, a product name, a product price, a product function, or a combination thereof. It is understood that the invention is not limited thereto. The vectorized data C1 is the vectorized data of a user g, and the vectorized data C2 is the vectorized data of a user h. The vectorized data C1 and C2 can be classified into a grouped data G3. The data processing unit 10 determines that the user h is the target to be awakened based on the sales promotion data 700. The artificial intelligence module 30, according to the grouped data G3 where the user h is allocated, respectively matches the classification labels included in the vectorized data C1, C2 contained in the grouped data G3 to the classification labels of the product data. For example, the user g has searched for cheap bluetooth earphones and purchased pens. As a result, a 3C product label, a wireless transmission label, a price range label, a stationery label, etc. are assigned to the user g. The user h has clicked on the advertisement hyperlinks of simple home appliances and purchased a notebook computer, so that a 3C product label, a wireless transmission label, a price range label, a home appliances label, etc. are assigned to the user h. When a user operates the information device 2 to sell a second-hand mobile phone, the data processing unit 10 determines that the user h is the target to be awakened based on the sales promotion data 700. According to the grouped data G3 where the user h is allocated, the artificial intelligence module 30 matches the 3C product label, the price range label, the wireless transmission label, the stationery label, etc., included in the grouped data G3 to the classification labels of the product data. For example, the household appliance label and the price range are assigned to the sweeping robots while the wireless transmission label and the stationery label are assigned to the voice recorder, etc. In this way, the artificial intelligence module 30 determines that the user h may need the sweeping robot and the voice recorder, and then generates matching data: the sweeping robot and the voice recorder.

The product price in the product data corresponds to the price range label included in the path data. The price range label is used to define the consumption power of the user. For example, a user i buys a high-priced mechanical watch so that a high price label and a watch label are assigned to him. According to the grouped data of the user i, the artificial intelligence module 30 matches the high price label and the watch label to the product data, so the matching data will not include the low-priced watch.

Extracting product data 206: The data processing unit 10 extracts a related product data related to the matching data in the product database 23 based on the matching data.

Transmitting product data 207: The system 1 for awakening non-shopping consumers of the present invention transmits relevant product data to the information device 2 operated by the user, so as to provide more products that the user may purchase. The product data may serve as reference for the user's shopping choice. Meanwhile, the matching data may be provided to the user to promote more products to consumers.

Accordingly, the data processing unit of the present disclosure mainly classifies the path data labels generated by the user's operation of the information device based on a plurality of classification labels, and then converts the path data into vectorized data by an artificial intelligence module that has been trained for learning. Thereafter, the vectorized data are classified into grouped data. Meanwhile, the data processing unit determines whether the user is the target to be awakened according to the user's path data, such as the purchase cycle and product cycle. Furthermore, based on multi-dimensional considerations, the artificial intelligence module generates matching data with respect to consumer behavior and product attributes. Finally, based on the matching data, the data processing unit provides products that meet the needs of consumers and transmits them to the information device as a reference for the user's shopping choice. Meanwhile, the matching data may be provided to the user to increase the accuracy of the products to be promoted, thereby arousing consumers' desire to buy products. In this way, the effect of waking up consumers who have not shopped for a long time is achieved.

### REFERENCE SIGN

1 system for awakening non-shopping consumers
2 information device
10 data processing unit
21 label database
22 path database
23 product database
30 artificial intelligence module
301 website page
302 search unit
303 purchase unit
304 advertisement unit
700 sales promotion data
201 receiving path data
202 extracting analysis data
203 vectorizing and grouping path data
204 determining the target to be awakened
205 matching analysis result
206 extracting product data
207 transmitting product data
A1, A2, A3, A4, A5, A6 vectorized data
B1, B2, B3 vectorized data
C1, C2 vectorized data
G1, G2, G3 grouped data
t tangent

What is claimed is:

1. A system for awakening non-shopping consumers, being in informational connection with an information device, comprising:
an information processing unit in informational connection with a label database, a path database, a product database, and an artificial intelligence module;
the artificial intelligence module is configured to vectorized analyze a path data in the path database into a vectorized data, and then classify a plurality of the vectorized data into a grouped data;
the data processing unit is configured to determine based on a plurality of classification labels of the path data whether a user corresponding to the path data is a target to be awakened;
the artificial intelligence module is configured to match the grouped data to at least one product data in the product database based on the target to be awakened to generate a matching data; and
the data processing unit is configured to extract a relevant product data related to the matching data in the product database based on the matching data, and transmit the relevant product data to the information device.

2. The system for awakening non-shopping consumers as claimed in claim 1, wherein the label database includes the plurality of classification labels, which are used by the data processing unit to classify an input data transmitted by the information device.

3. The system for awakening non-shopping consumers as claimed in claim 1, wherein the path data is one or a combination of a website trigger event, a website click event, a website operation behavior, a website stay time, and a derivative data under the website operation behavior.

4. The system for awakening non-shopping consumers as claimed in claim 1, wherein the data processing unit determines according to a purchase time point, a purchase cycle, and a product cycle corresponding to the classification label whether the user corresponding to the path data is the target to be awakened.

5. The system for awakening non-shopping consumers as claimed in claim 4, wherein the data processing unit determines that the user is listed as the target to be awakened if the user's purchase time point is greater than the purchase cycle.

6. The system for awakening non-shopping consumers as claimed in claim 5, wherein the data processing unit determines that the user is listed as the target to be awakened if the user's purchase time point is greater than the product cycle.

7. A method for awakening non-shopping consumers, comprising:
extracting a plurality of path data in a path database and at least one product data in a product database via a data processing unit for vectorized analysis by an artificial intelligence module, wherein the path data and the product data each comprises a plurality of classification labels;
performing vectorized analysis on the path data to generate a vectorized data via the artificial intelligence module whereupon a plurality of vectorized data are defined as a grouped data with the plurality of classification labels;
determining a target to be awakened via the data processing unit based on the plurality of classification labels of the path data;
generating a matching data by matching the grouped data to the product data via the data processing unit based on the target to be awakened,
extracting a related product data related to the matching data in the product database based on the matching data via the data processing unit; and
transmitting the related product data to the information device.

8. The method for awakening non-shopping consumers as claimed in claim 7, further comprising:
receiving the plurality of path data transmitted by the information device;
performing the label classification on the plurality of path data based on the plurality of classification labels in a label database via the data processing unit; and
transmitting the plurality of path data to the path database for storage.

9. The method for awakening non-shopping consumers as claimed in claim 7, wherein the path data is one or a combination of a website trigger event, a website click event, a website operation behavior, a website stay time, and a derivative data under the website operation behavior.

10. The method for awakening non-shopping consumers as claimed in claim 7, when the data processing unit determines the target to be awakened with the plurality of classification labels, further comprising:
extracting at least one path data in the path database, determining a corresponding user and checking whether a purchase time point of the corresponding user is greater than a purchase cycle of the corresponding user, wherein, if so, the user is listed as the target to be awakened, and if not, the data processing unit extracts another path data in the path database.

11. The method for awakening non-shopping consumers as claimed in claim 7, when the data processing unit determines the target to be awakened with the plurality of classification labels, further comprising:
extracting at least one path data in the path database, determining a corresponding user and checking whether a purchase time point of the corresponding user is greater than a product cycle, wherein, if so, the user is listed as the target to be awakened, and if not, the data processing unit extracts another path data in the path database.
